(19) United States
(12) Patent Application Publication
(10) Pub. No.: US 2010/0111040 A1
(43) Pub. Date: May 6, 2010

(54) METHOD AND APPARATUS FOR FAST BREAK-BEFORE-MAKE MEDIA INDEPENDENT HANDOVER

(75) Inventor: Michelle Perras, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/608,241

(22) Filed: Oct. 29, 2009

Related U.S. Application Data
(60) Provisional application No. 61/109,616, filed on Oct. 30, 2008.
(60) Provisional application No. 61/232,217, filed on Aug. 7, 2009.

(51) Int. Cl. H04W 36/00

(52) U.S. Cl. 370/331

(57) ABSTRACT

A method and apparatus may be used to perform a Media Independent Handover. Data may be received from a source node in a source network serving a WTRU. The WTRU may transmit a first message to an intermediary node and receive a second message in response. The WTRU may establish connectivity on a target network and receive data from a target node.

### CROSS REFERENCE TO RELATED APPLICATIONS

This application claims the benefit of U.S. Provisional Application Nos. 61/109,616 filed on Oct. 30, 2008 and 61/232,217 filed on Aug. 7, 2009, which are hereby incorporated by reference.

### TECHNOLOGY FIELD

The present disclosure relates to wireless communications.

### BACKGROUND

Typical radio access technologies may have defined mechanisms to control Network Discovery and Selection (NWDS). However, few mechanisms have been defined for heterogeneous network environments, where several different radio access technologies are available for a wireless transmit/receive unit (WTRU). Instead, it has typically been left to the WTRU and a user of the WTRU to handle network discovery and selection.

For example, Media Independent Handover (MIH) Services is a standard developed by Institute of Electrical and Electronics Engineers (IEEE) in the 802 family of standards. The MIH standard (IEEE 802.21) specifies access-independent mechanisms that optimize handovers between heterogeneous access networks, both wired and wireless. MIH mechanisms may be used for handovers between 802 networks and non-802 networks.

The purpose of the MIH client may be to allow efficient software implementations of handover between different technologies, for example, Wireless Broadband (WiBro) and Universal Mobile Telecommunications System (UMTS). Additional purposes of the MIH client may include enabling any of the following: automatic inter-technology mobility at both Layer 2 and Layer 3; reduced handover interruption time; and provide quality of service (QoS) optimization across technologies.

FIG. 1 depicts an intermediary node, such as an MIH server, configured to control handover 100. According to the handover procedure as shown in FIG. 1, handover may be assisted by WTRU 105 as well as Mobile Internet Protocol (MIP) registration. As shown in FIG. 1, an MIH client 110 and MIP client 111 may be provided on the WTRU 105. A binding entry 125 for the WTRU 105 may also exist at a source node such as a Home Agent (HA) 130. The HA may be a router, or any other type of device, on a WTRU's home network that may tunnel data for delivery to the WTRU when it is away from home. The HA may maintain a current location for the WTRU, such as an IP address. The HA may be used with one or more target nodes, such as a Foreign Agent (FA). A FA may be a router, or any other type of device, that stores information about WTRUs visiting its network. FAs may also advertise care-of-addresses (CoAs) which may be used by MIP. A CoA of a WTRU may be a physical IP address of the device when operating in a foreign network.

When link quality degrades 135, the MIH client may communicate a LinkGoingDown (low confidence) message 136 to the MIH server 137. The MIH client 110 may also communicate a measurement report 138 and a LinkGoingDown (high confidence) message 139 to the MIH server 137. The MIH server 137 then may decide to initiate a handover 140. The MIH server 137 may communicate a handover request message 141 to the MIH client 110.

The WTRU 105 may then turn down its current link on Network A 142, resulting in connectivity being interrupted. The WTRU 105 may begin to establish Layer 2 connectivity on Network B 143. The WTRU 105 may trigger MIP registration 144. The MIP client 111 may transmit a Router Solicitation message 145 to a target node, such as a FA 120 in Network B. The FA 120 may respond with an Agent Advertisement (List of CoAs) message 146. The MIP client 111 may send an MIP Register (WRTU+COA) message 147 to the FA 120. The FA 120 then may send an MIP Register (WTRU+CoA) message 148 to the HA 130. The HA 130 then may update its binding entry 125 with the new CoA (not shown).

After the HA 130 updates its binding entry 125, Layer 3 connectivity may be resumed. The HA 130 may transmit an MIP Register Response message 150 to the FA 120. The FA 120 may transmit an MIP Register Response message 155 to the MIP client 111. The MIH client 110 then may send a Handover Completed message 160 to the MIH server 137. The HA 130 may then forward data from the correspondent peer to the WTRU 105 using the new CoA 165.

In typical break-before-make (BBM) approaches to MIH handover, a current link is torn down before a new connection is established on the target network. According to this approach, only one transmitter may be enabled at a time. Using a make-before-break approach (MBB), a new connection may be established on the targeted network before terminating the current connection. According to this approach, two or more transmitters may be enabled at the same time. The disadvantages of current MBB approaches, however, may include power consumption and radio interference issues when two or more transmitters are enabled at the same time in a single device.

In typical BBM approaches, an interruption period may occur following the current connection being torn down and prior to a new connection being established on the new network. This may have the undesirable effect of creating data loss during the interruption period. Interruption periods may not be of uniform length. Many steps may be performed before connectivity is resumed. For example, one step may be obtaining Layer 2 connectivity on the targeted network. Obtaining Layer 2 connectivity may depend on the technology that is used on the targeted network. For example, when connecting to a UMTS target network, the WTRU may camp on a cell, attach to the network, and activate a Packet Data Protocol (PDP) context. A second step may be updating the MIP registration/CoA allocation/FA discovery with the Home Agent (HA). This may involve sending a Router Solicitation message, waiting for an Agent Advertisement, and sending an MIP registration request to the HA.

### SUMMARY

A method and apparatus may be used to perform a Media Independent Handover. Data may be received from a source node in a source network serving a WTRU via an intermediate node. The WTRU may transmit a first message to an intermediary node and receive a second message in response. The WTRU may establish connectivity on a target network and receive data from a target node.

The WTRU may receive data from a source node in a source network serving the WTRU. The WTRU may transmit a first message to an intermediary node, the first message including an indication of a location of the WTRU and an indication of a target network. In response, the WTRU may receive a second message from the intermediary node, the second message including an indication of an internet protocol (IP) address of a target node. The WTRU may then establish connectivity on the target network and receive data from the target node.

A target node may receive a first message from a source node and transmit a second message to the source node. The target node may also receive a third message from the source node indicating a WTRU to be registered and transmit a fourth message to the source node before forwarding data to the WTRU.

An intermediary node may transmit a first message to a source node, the first message indicating a dual MIP binding for a WTRU. In response, the intermediary node may receive a second message from the source node. The intermediary node may perform a determination to initiate handover of the WTRU; and transmit a Handover Request.

### BRIEF DESCRIPTION OF THE DRAWINGS

A more detailed understanding may be had from the following description, given by way of example in conjunction with the accompanying drawings wherein:

FIG. 1 is a diagram of a typical method for Media Independent Handover (MIH)-based handover;

FIGS. 2A and 2B are a diagram of an example method for MIH-based handover that may include the use of Media Independent Information Services (MIIS);

FIGS. 3A and 3B are a diagram of an example method for MIH-based handover that may not include the use of Media Independent Information Services (MIIS); and

FIGS. 4A and 4B are a diagram of an example method for MIH-based handover that may include the use of Proxy Mobile Internet Protocol (PMIP);

FIGS. 5A and 5B are a diagram of an example method for MIH handover where the MIP pre-registration may be performed by the MIH client;

FIGS. 6A and 6B are a diagram of an example method for MIH handover where PMIP may be triggered by the MIH client;

FIG. 7 is a diagram of an example method where the MIH server may send an Agent Solicitation message.

FIG. 8 shows a wireless communication system/access network; and

FIG. 9 is an example block diagram of the wireless communication system/access network of FIG. 8.

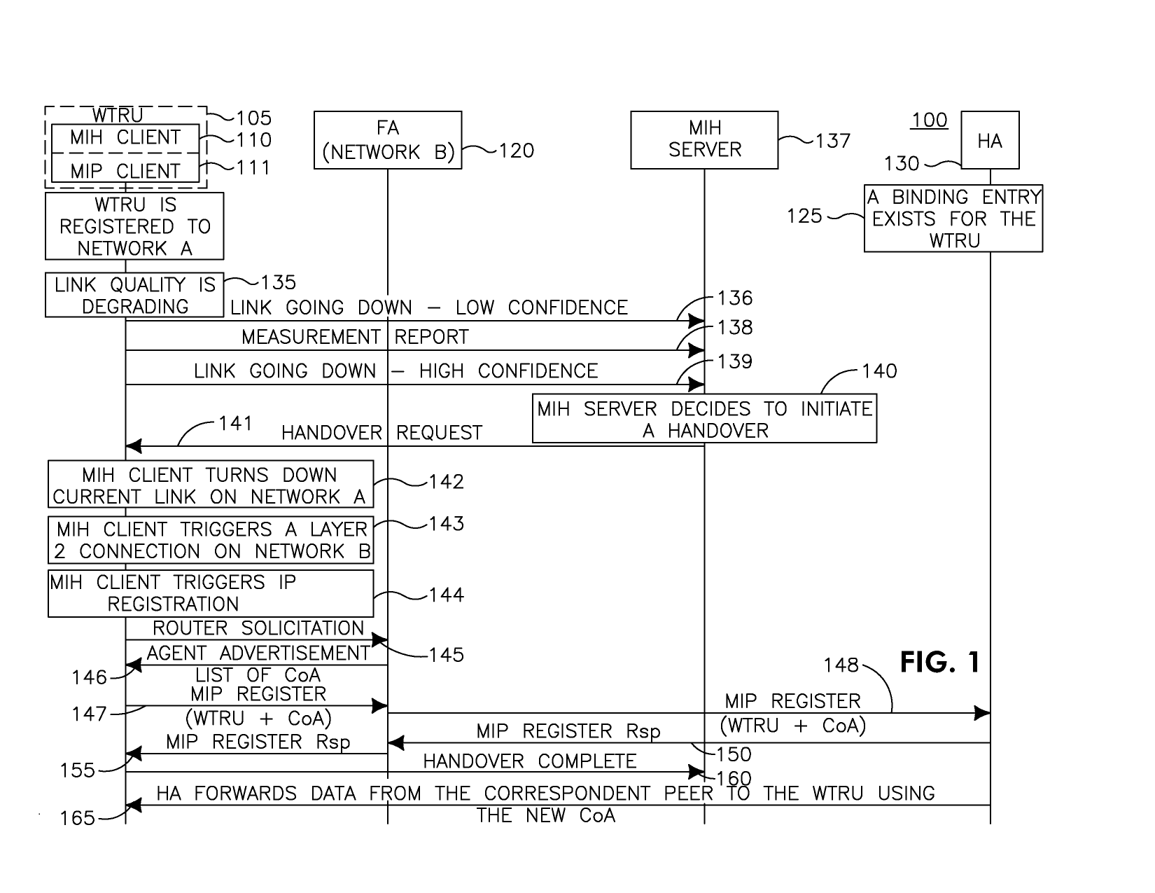

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment. The embodiments described herein may be configured to operate using MIP, Fast Mobile IP (FMIP), Hierarchical Mobile IP (HMIP), and other mobility technologies.

For purposes of explanation, the various embodiments are described in an 802.xx context, but the various embodiments may be implemented using any handover technology that supports inter-network handover. For example, in a Third Generation Partnership Project (3GPP) scenario, an Access Network Discovery and Selection Function (ANDSF) may be used to assist WTRUs in discovering and selecting heterogeneous access networks. The ANDSF may be used for the Interworking of 3GPP and non-3GPP networks. Other types of handover technologies may be applied to any type of network, for example Worldwide Interoperability for Microwave Access (WiMAX), Wireless Local Area Network (WLAN), Global System for Mobile communications (GSM), Code Division Multiple Access (CDMA2000), Universal Mobile Telecommunications System (UMTS), Long Term Evolution (LTE), or any future technology.

A wireless network may include an inter-technology handover server, for example as an MIH server, an ANDSF server, or any other device or intermediary node that may be used to assist WTRUs in discovering and in deciding which network to access. These types of devices may be used to centralize decisions regarding the handover of sessions among multiple access points and multiple access technologies, either alone or in combination with other functions. Such devices may allow a wireless network operator to balance the traffic load so as to alleviate congestion on specific access points, and deliver sufficient QoS to all users.

In an 802.xx scenario, for example, the MIH server may be in communication with an MIH client and a source node such as an HA. The MIH server and HA may be co-located or may be in communication with each other. An MIH server may be in communication with an intermediary node such as a Media Independent Information Services (MIIS). The MIH server and MIIS may be co-located. The MIIS may be able to determine which FA in a targeted network is reachable from a WTRU after the handover of the WTRU to the targeted network is completed. The HA may be able to send an MIP registration to the FA on behalf of the WTRU. The WTRU may include an MIP client. The MIP client may be used by the WTRU when connecting to the targeted network during handover. The FA IP address may be obtained based on the targeted network and/or current WTRU location.

A method and apparatus may be used to reduce the interruption interval resulting from a BBM handover by performing an MIP pre-registration on a targeted network before tearing down a current link. To perform the pre-registration, the MIIS and HA may obtain the Care of Address (CoA) of the target FA and communicate the CoA to the WTRU. The target FA's CoA may be obtained before terminating the connection on the source network (Network A). The MIP binding entry for the target network (Network B) may be added on the HA for simultaneous binding using the targeted CoA and may be created on the targeted FA (MIP pre-registration) before terminating the connection on Network A.

The MIH server may initiate the MIP pre-registration with the HA and the HA may send the MIP pre-registration to the FA on behalf of the WTRU. A Proxy Mobile Internet Protocol (PMIP) node on the current network may send an MIP pre-registration to the targeted FA on behalf of the WTRU. The MIH client on the WTRU may trigger MIP pre-registration to the targeted FA while still connected on the current Network A. As a result, since the MIP binding has been updated, the data from the correspondent node may reach the WTRU upon establishing Layer 2 connectivity.

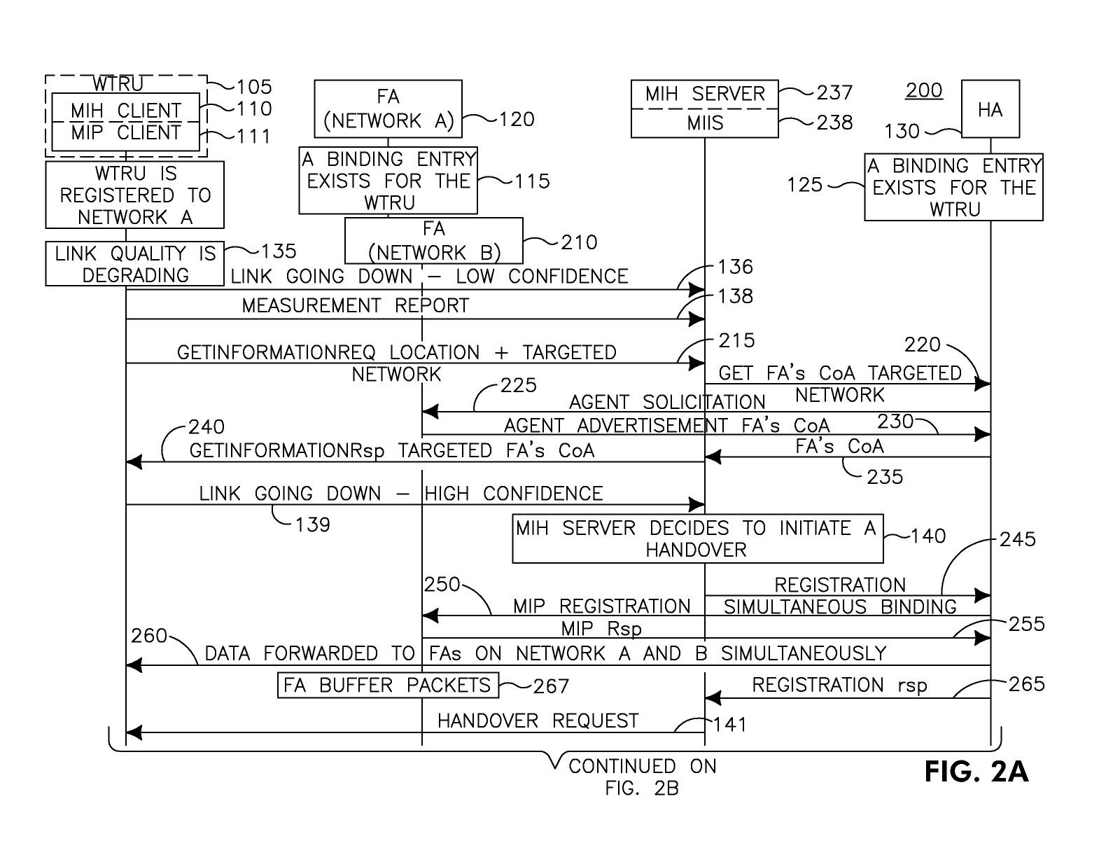

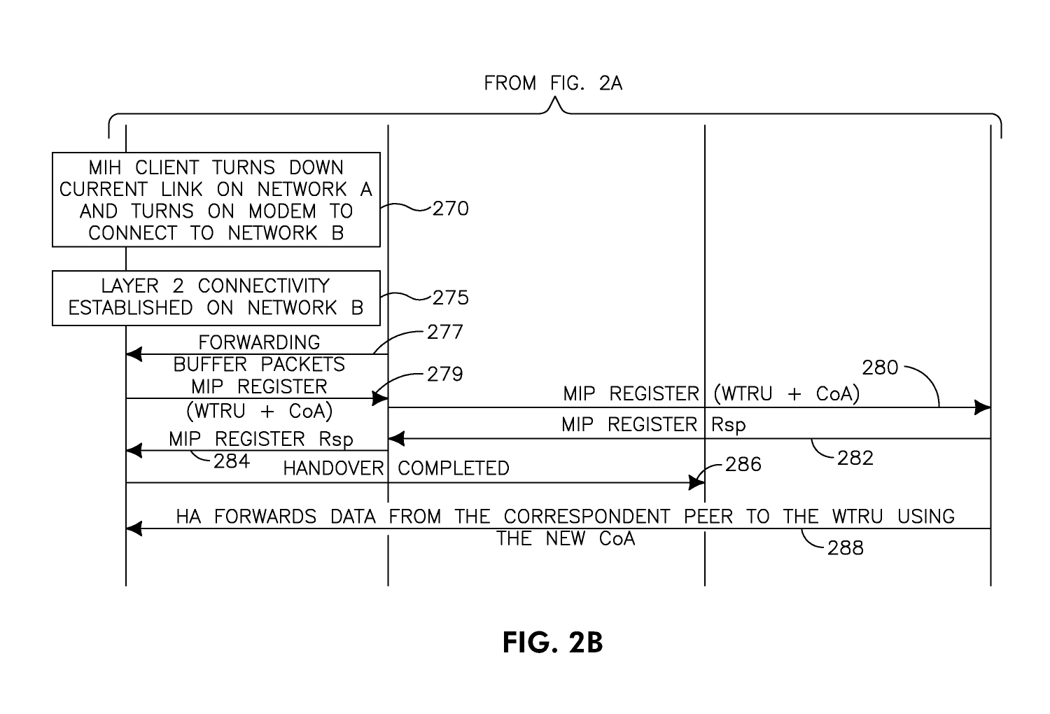

FIGS. 2A and 2B are a diagram of a method for handover 200. As shown in FIG. 2A, the WTRU 105 may initiate an acquisition of a targeted MIP CoA, and the MIH server 237 may initiate an MIP pre-registration with the HA 130 and the targeted FA 210.

As shown in FIG. 2A, the MIH client 110 and MIP client 111 may be present on a WTRU 105 in a memory unit, or a processor, etc. In the examples detailed below, the network currently serving the WTRU 105 is referred to as Network A and the target network is referred to as Network B. The MIH server 237, MIIS 238, and HA 130 may be communicating on Network A. In this example, the WTRU 105 may be registered on Network A, and an MIP binding entry 115, 125 may exist for the WTRU 105 on the FA 120 on Network A and the HA 130.

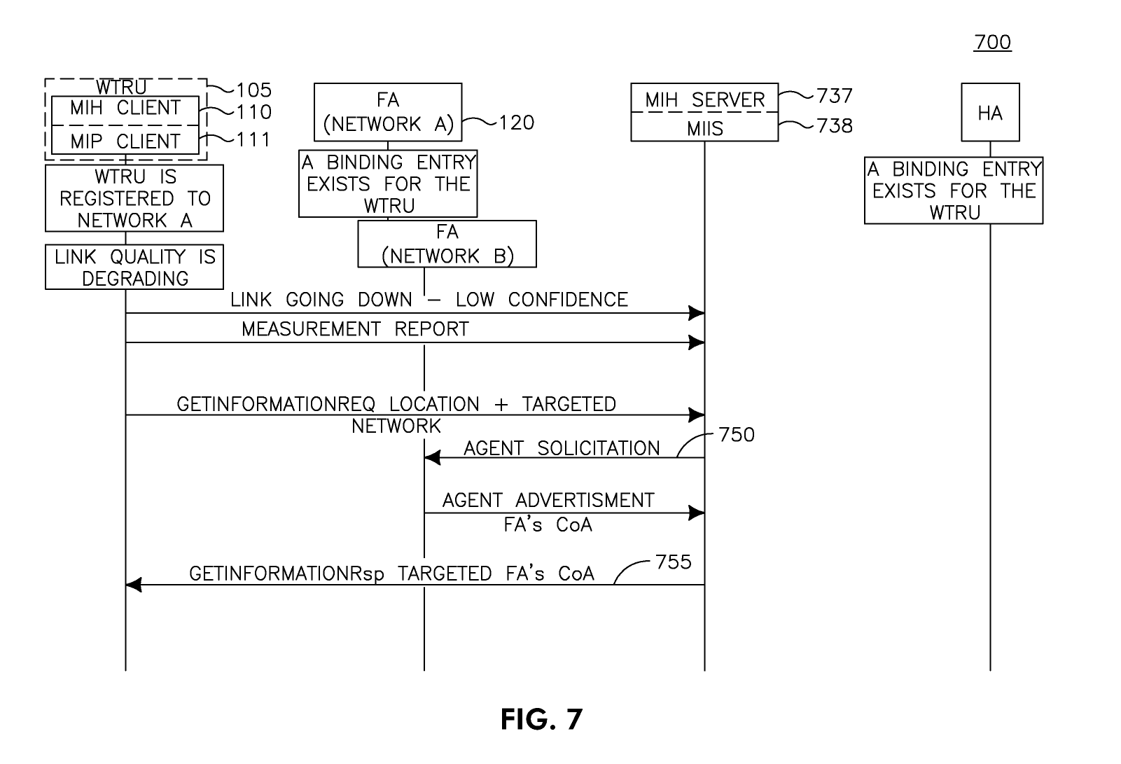

When the WTRU 105 detects that its link quality is degrading 135, it may transmit a LinkGoingDown (low confidence) message 136 and a measurement report 138 to the MIH Server 237. The MIH client 110 then may send a GetInformationReq message 215 to the MIIS 238. Other triggers for transmitting the GetInformationReq message may include, for example, an internal decision by the MIH client based on internal policies, a trigger from applications running on the WTRU, etc. The MIIS 238 may be co-located with the MIH server 237. The WTRU's location and targeted network may be specified in the GetInformationReq message 215. The targeted network may be, for example, a UMTS network. The MIIS 238 may transmit a message 220 to the HA 130 to obtain the CoA of the targeted FA 210. The HA 130 may send an Agent Solicitation Message 225 to the target FA 210 to obtain the target FA's CoA. The target FA 210 may respond to the HA 130 with an Agent Advertisement Message 230 that may include the FA's CoA. The HA 130 may transmit the FA's CoA 235 to the MIIS 238, which then may transmit a GetInformationResp message 240 to the MIH client 110 that includes the FA's CoA. The CoA may be the target address that the WTRU will register to during handover. The targeted CoA may be obtained using an alternative method as described in FIG. 7.

The MIH client 110 may transmit a LinkGoingDown (high confidence) message 139 to the MIH server 237, when link quality is poor. The MIH server 237 may decide to initiate a handover. Before handover, the MIH server 237 may trigger registration of the WTRU 105 with the target FA 210, and may create a dual CoA entry in the HA 130.

The MIH server 237 may send a registration (dual/simultaneous binding) message 245 to the HA 130. The HA 130 may update the WTRU binding entry 125 to include two bindings, a first binding for Network A and a second binding for Network B. The HA 130 may pre-register the WTRU 105 on Network B by sending an MIP registration message 250 to the target FA 210. The data destined to the WTRU 105 may be forwarded to both FAs 120, 210. Since the WTRU 105 may still be connected to Network A, it may continue to receive the data forwarded from the FA 120. The FA 210 may buffer packets 267 until the WTRU 105 establishes Layer 2 connectivity with the FA 210. In this example, there is no need for a tunnel between the two FAs 120, 210.

The FA 210 may respond to the HA 130 by sending an MIP Rsp message 255. The MIP Rsp message 255 may include a new CoA. The HA 130 may add the new CoA(B) to the binding entry while keeping the previous CoA(A). Data may be forwarded 260 from the HA 130 to the FA 120 on Network A as well as the target FA 210. The FAs 120, 210 may forward the data to the WTRU 105. Duplicated data sent from Network B may be lost. The HA 130 may send a Registration Rsp message 265 to the MIH server 237 to indicate that MIP registration is complete. In response, the MIH server 237 may send a Handover Request message 141 to the WTRU 105.

The WTRU 105 may turn down 270 its current link on Network A and turn on a modem to connect to Network B. When the WTRU 105 turns down its current link on Network A, connectivity may be interrupted. The WTRU 105 then may establish Layer 2 connectivity on Network B 275. Layer 3 connectivity may be resumed since the MIP registration was performed prior to initiating the handover. The FA 210 may forward the buffered packets 277 to the WTRU 105 and stop buffering. The MIH client 110 may trigger MIP registration using the previously-received CoA. The MIH client 110 may send an MIP Register message 279 to the FA 210 on Network B. The MIP Register message 279 may include a home IP address, i.e. the IP address assigned by the HA to the WTRU and a CoA, together referred to as (WTRU+CoA). The home IP address may not change when the WTRU moves to another FA. The CoA may change as the WTRU moves to another FA and may be allocated by the FA. The binding entry at the FA and HA may include the WTRU home address and a current CoA. The FA 210 on Network B sends an MIP register message 280 to the HA 130. The MIP register message 280 may include (WTRU+CoA). The HA 130 may remove the duplicate binding entries, retaining only the new CoA for the WTRU 105. The HA 130 may respond to the FA 210 by sending an MIP Register Rsp message 282. The FA 210 in Network B may send an MIP Register Rsp message 284 to the WTRU 105. The WTRU 105 may send a Handover Completed message 286 to the MIH server 237. The HA 130 may forward data 288 to the WTRU via the Network B using the new CoA.

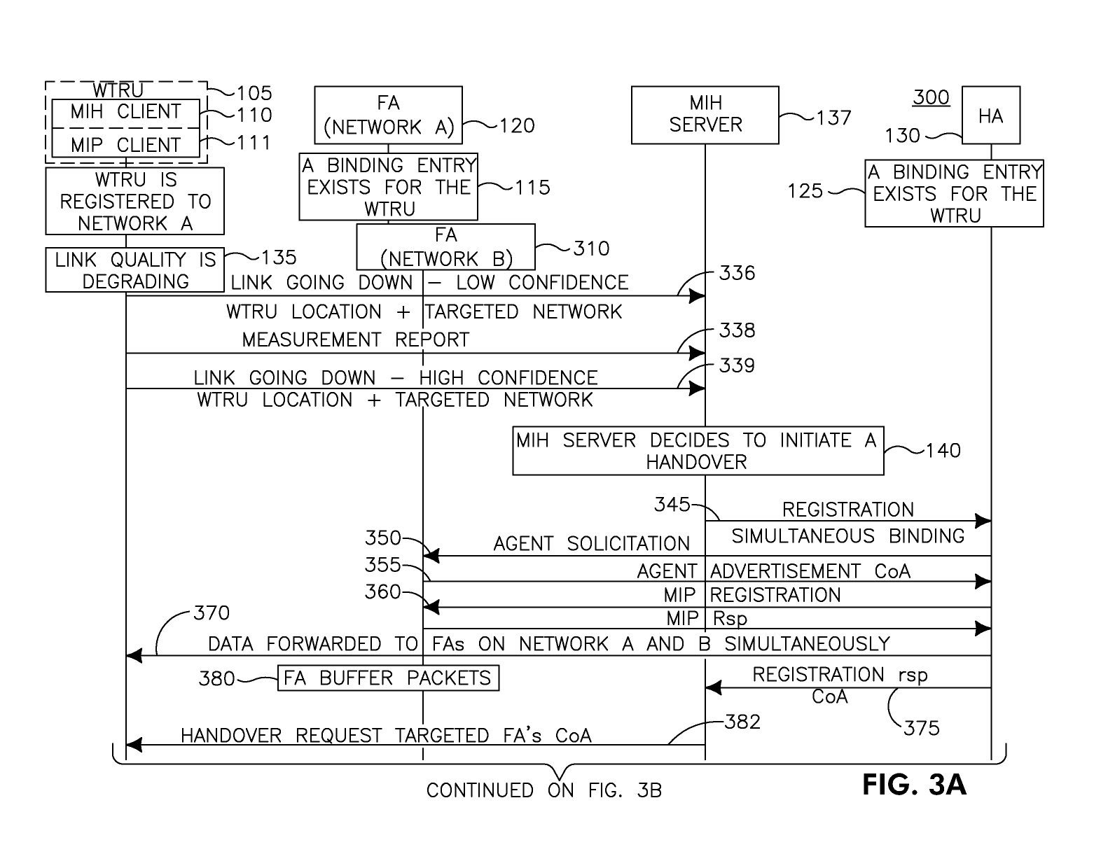

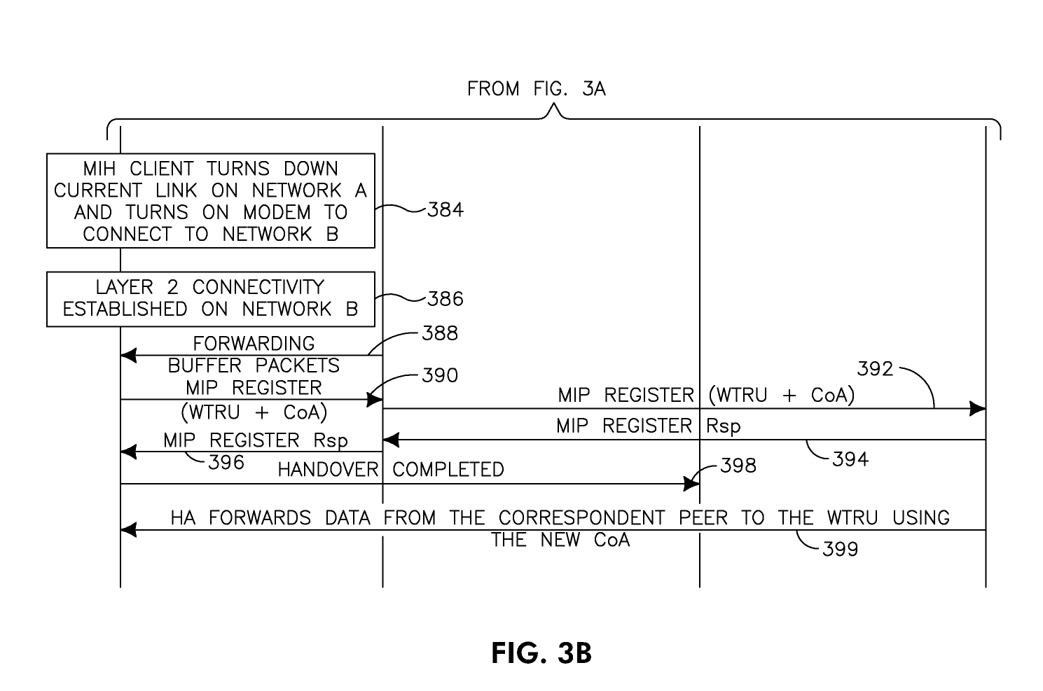

FIGS. 3A and 3B are a diagram of another method for MIH handover 300. As compared to the method of FIGS. 2A and 2B, the method of FIGS. 3A and 3B does not include the use of the MIIS. Additionally, the method of FIGS. 3A and 3B differs from the method of FIGS. 2A and 2B in the following ways: indications of the WTRU's location and targeted network may be sent in the LinkGoingDown message; the Agent Solicitation and Agent Advertisement messages may be sent only when the decision to trigger handover is made; and the FA's CoA may be forwarded to the MIH client with the Handover Request instead of with the GetInformationRsp message. Efficiencies provided by the method of FIGS. 3A and 3B include: fewer messages may be communicated between the WTRU and the MIH server; the MIH server may receive an update of the WTRU's location before triggering handover since two LinkGoingDown messages may be sent, resulting in more efficient detection of the targeted FA; and Agent Solicitation and Advertisement messages may be sent only if the decision to trigger handover is made. Additional aspects of the method of FIGS. 3A and 3B may include the MIH server initiating the acquisition of the targeted CoA, the MIH server initiating the MIP re-registration with the HA and the targeted FA, and the WTRU receiving the targeted CoA with the Handover Request message.

As shown in FIG. 3A, the WTRU 105 may include an MIH client 110 and an MIP Client 111. The WTRU 105 may be registered to Network A, and a binding entry 115, 125 may exist for the WTRU at the FA 120 in Network A and at the HA 130. When the WTRU 105 detects that its link quality is degrading 135, it may send a LinkGoingDown (low confidence) message 336 to the MIH server. The LinkGoingDown (low confidence) message 336 may include the WTRU's location and an identifier of the targeted network. The WTRU 105 may send a measurement report 338 to the MIH server 137. The WTRU 105 may send a LinkGoingDown (high confidence) message 339 to the MIH server 137, including the WTRU's location and an identifier of the targeted network. The MIH server 137 may decide to initiate handover.

The MIH server 137 may send a Registration (simultaneous binding) message 345 to the HA 130. The HA 130 may send an Agent Solicitation message 350 to the target FA 310, which is in Network B. The target FA 310 may send an Agent Advertisement message 355 to the HA 130, including the target FA's CoA. This is how the HA 130 may obtain the target FA's CoA while the WTRU 105 is still on Network A. The HA 130 may send an MIP Registration message 360 to the target FA 310. The target FA 310 may send an MIP Rsp message 365 to the HA 130. The HA 130 may add the new CoA(B) binding entry for the WTRU while retaining the previous CoA(A) entry. At this point, MIP data may be forwarded 370 to both the target FA 310 and the FA 120 on Network A. Both FAs may forward the data to the WTRU 105. The HA 130 may send a Registration Rsp message 375 to the MIH server 137, which may include the target FA's CoA. The FA 310 may buffer packets 380 until the WTRU 105 establishes Layer 2 connectivity with the FA 310.

The MIH server 137 may send a Handover Request message 382 to the WTRU 105. The Handover Request message 382 may include the targeted FA's CoA. The WTRU 105 may turn down 384 its current link on Network A, causing an interruption of connectivity, and establish Layer 2 connectivity 386 on Network B. Layer 3 connectivity may be resumed since the MIP registration was performed prior to initiating the handover. The FA 310 may forward the buffered packets 388 to the WTRU 105 and stop buffering. The MIH client 110 may trigger MIP registration using the previously-received CoA. It may send an MIP Register message 390 including (WTRU+CoA) to the FA 310 on Network B. The FA 310 on Network B may send an MIP register message 392 including (WTRU+CoA) to the HA 130. The HA 130 may remove the duplicate binding entries, retaining only the new CoA for the WTRU 105. The HA 130 may respond to the FA 310 by sending an MIP Register Rsp message 394. The FA 310 in Network B may send an MIP Register Rsp message 396 to the WTRU 105. The WTRU 105 may send a Handover Completed message 398 to the MIH server 137. The HA 130 may forward data 399 from the Network B using the new CoA.

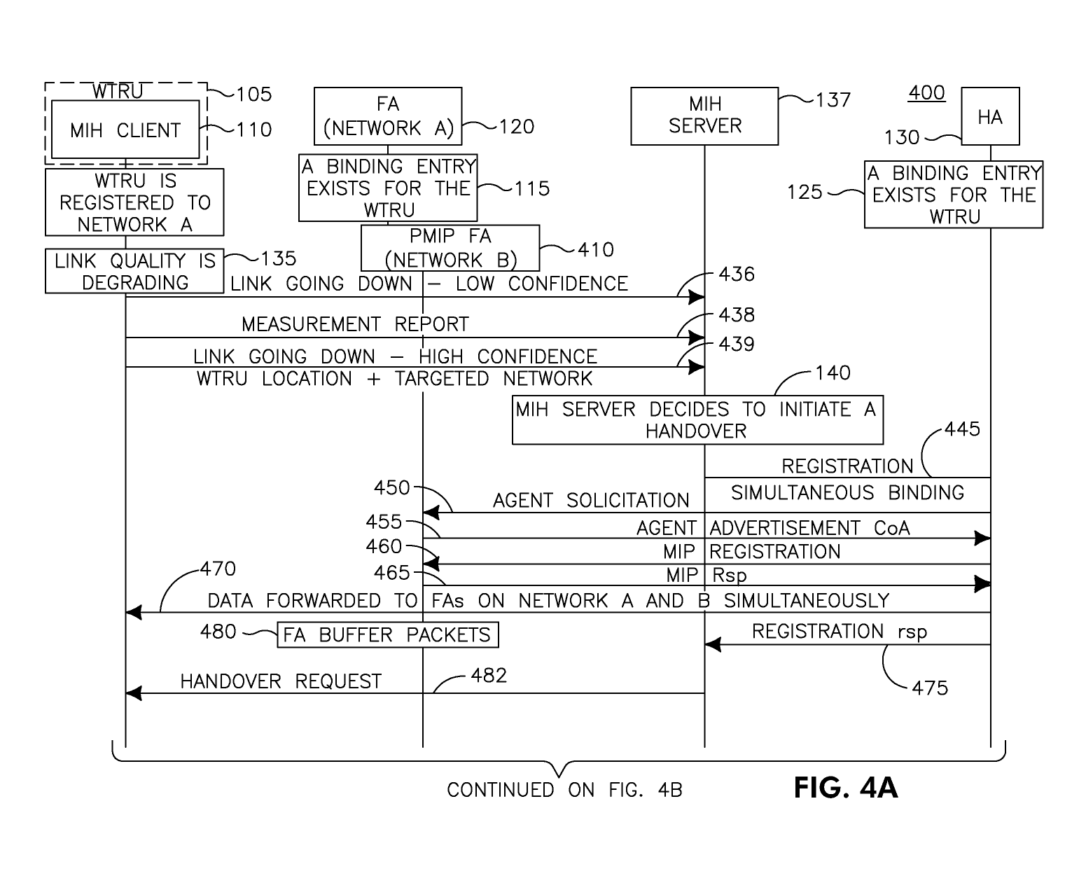

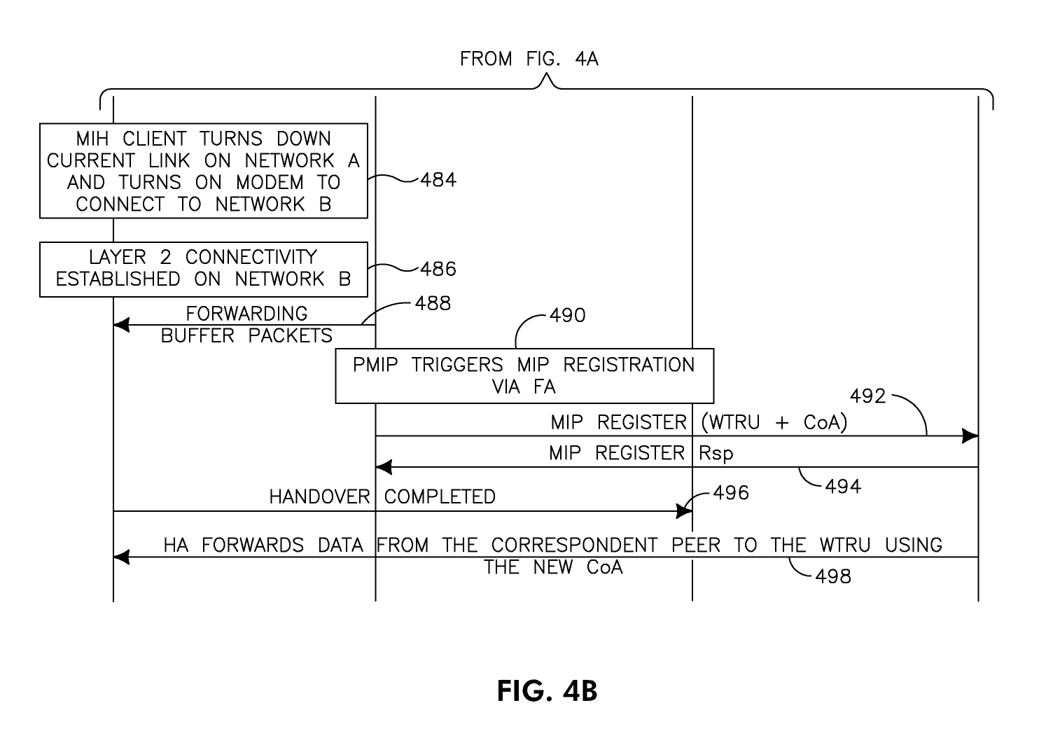

FIGS. 4A and 4B are a diagram of a method for MIH handover 400 where Proxy MIP (PMIP) may be used. As PMIP is used in this method, it may not be required that the CoA is transmitted to the WTRU. As compared to the methods of FIG. 2 and FIG. 3, the MIP pre-registration may be performed by the HA on the targeted network (Network B). The method of FIGS. 4A and 4B differs from the methods of FIGS. 2A/2B and FIGS. 3A/3B in the following ways: when the WTRU connects to the target network, PMIP may trigger the FA for MIP registration; since a binding entry may already exist on the FA resulting from the previously performed MIP pre-registration, the same CoA may be used on the MIP registration sent to the HA; and the HA may receive the MIP registration and overwrite the existing binding entry, removing the simultaneous bindings that may result in the loss of the Network A binding. Other aspects of the method of FIGS. 4A and 4B may include: the MIH server initiating the acquisition of the targeted CoA; the MIH server initiating the MIP pre-registration with the HA and the targeted FA; and the WTRU may not be involved in MIP registration or pre-registration.

As shown in FIG. 4A, the WTRU 105 may include an MIH client 110 and may be registered on Network A. A binding entry 115, 125 may exist for the WTRU 105 at the FA 120 on Network A and at the HA 130. When the WTRU 105 detects that its link quality is degrading 135, it may send a LinkGoingDown (low confidence) message 436 to the MIH server 137. The WTRU 105 may send a measurement report 438 to the MIH server 137. The WTRU 105 may send a LinkGoingDown (high confidence) message 439 to the MIH server. The LinkGoingDown (high confidence) message 439 may include the WTRU location and the targeted network. The MIH server 137 may decide to initiate handover 140.

The MIH server 137 may send a Registration (simultaneous binding) message 445 to the HA 130. The HA 130 may send an Agent Solicitation message 450 to the target PMIP/FA 410, which is in Network B. The target PMIP/FA 410 may send an Agent Advertisement message 455 to the HA 130, including the target FA's CoA. This is how the HA 130 may obtain the target FA's CoA while the WTRU 105 is still on Network A. The HA 130 may send an MIP Registration message 460 to the target PMIP/FA 410. The target PMIP/FA 410 may send an MIP Rsp message 465 to the HA 130. The HA 130 may add the new CoA(B) binding entry for the WTRU while retaining the previous CoA(A) entry. At this point, MIP data may be forwarded 470 to both the target PMIP/FA 410 and the FA 120 on Network A. Both FAs may forward the data to the WTRU 105. The HA 130 may send a Registration Rsp message 475 to the MIH server 137, which may include the target FA's CoA. The FA 410 may buffer packets 480 until the WTRU 105 establishes Layer 2 connectivity with the FA 410.

The MIH server 137 may send a Handover Request message 482 to the WTRU 105. The Handover Request message 482 may include the targeted FA's CoA. The WTRU 105 may turn down 484 its current link on Network A, causing an interruption of connectivity, and establish Layer 2 connectivity 486 on Network B. Layer 3 connectivity may be resumed since the MIP registration was performed prior to initiating the handover. The FA 410 may forward the buffered packets 488 to the WTRU 105 and stop buffering. The PMIP/FA 410 may trigger MIP registration 490 via the FA on Network B. The FA on Network B may determine that a binding entry already exists for the WTRU 105. The FA may send an MIP Register message 492 including (WTRU+registered CoA) to the HA 130, using the same CoA that may be used for the MIP registration update. The HA 130 may retain only the new CoA. The HA 130 may send an MIP Register Rsp message 494 to the FA in Network B. The WTRU 105 may send a Handover Completed message 496 to the MIH server 137. The HA 130 may forward data 498 from the correspondent peer to the WTRU using the new CoA.

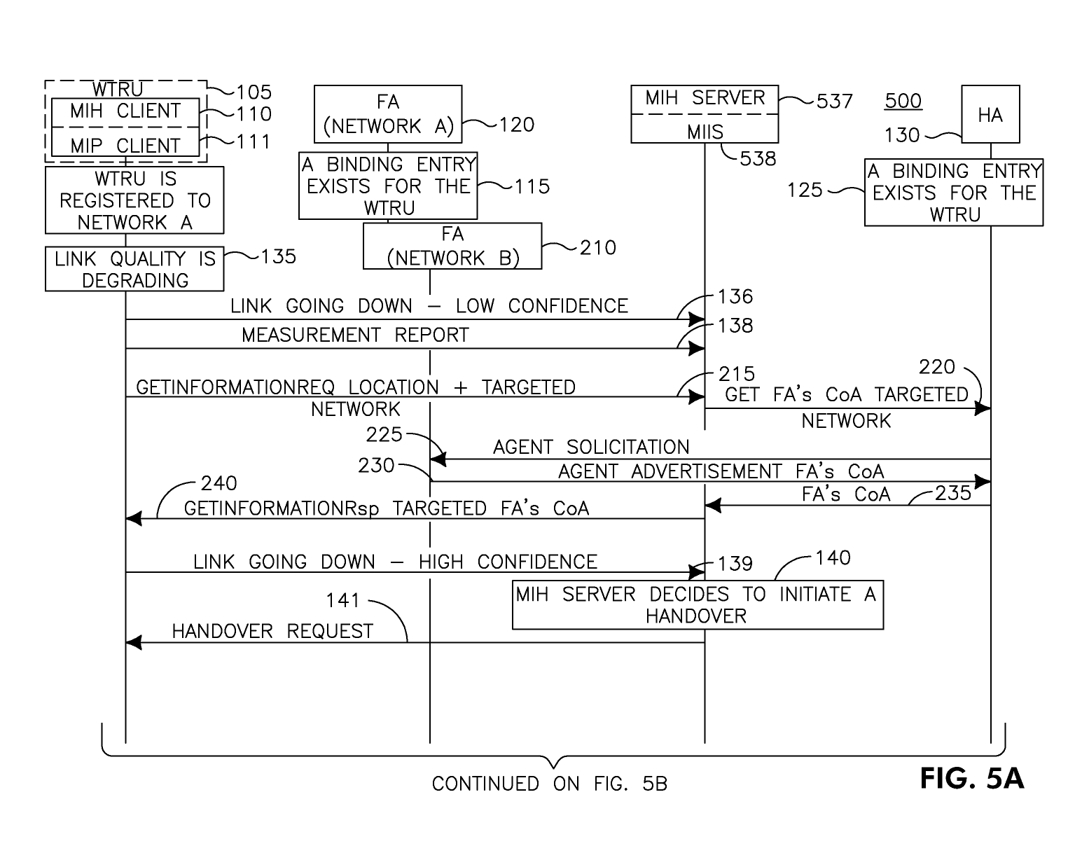

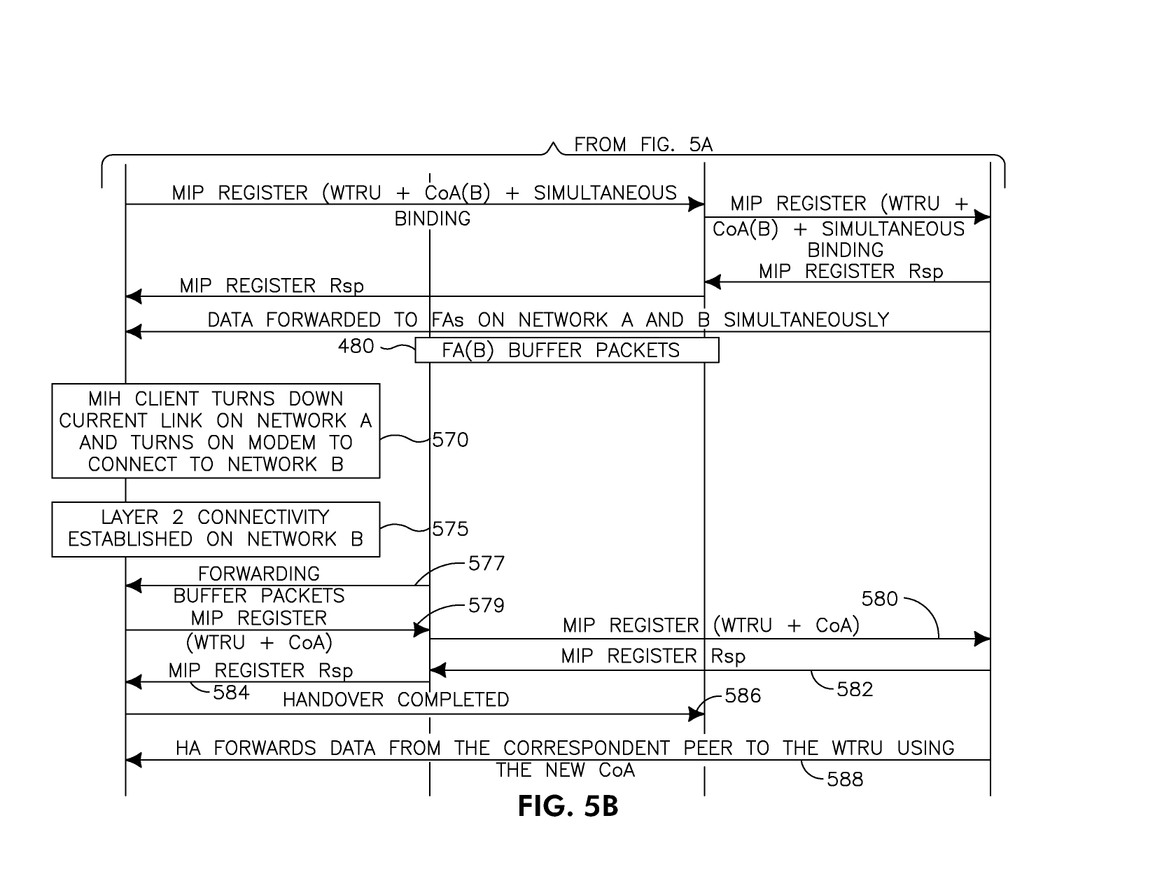

FIGS. 5A and 5B are a diagram of a method for MIH handover 500 where the MIP pre-registration may be performed by the MIH client. The MIH server may not be involved in this exchange. Additionally, the HA may not have to trigger the MIP registration with the FA, as compared to the method of FIGS. 2A/2B. As shown in FIGS. 5A and 5B, the MIH client 110 may initiate the acquisition of the targeted MIP Care of Address (CoA), and the MIH client 110 may initiate the MIP pre-registration with the HA 130 and the targeted FA 210.

As shown in FIG. 5A, the MIH client 110 and MIP client 111 may be present on a WTRU 105. The WTRU 105 may be registered on Network A, and an MIP binding entry 115, 125 may exist for the WTRU 105 on the FA 120 on Network A and the HA 130.

When the WTRU 105 detects that its link quality is degrading 135, it may transmit a LinkGoingDown (low confidence) message 136 and a measurement report 138 to the MIH Server 537. The MIH client 110 then may send a GetInformationReq message 215 to the MIIS 538. The MIIS 538 may be co-located with the MIH server 537. The WTRU's location and the targeted network may be specified in the GetInformationReq message 215. The targeted network may be, for example, a UMTS network. The MIIS 538 may transmit a message 220 to the HA 130 to obtain the Care of Address (CoA) of the FA 210. The HA 130 may send an Agent Solicitation Message 225 to the target FA 210 to obtain the target FA's CoA. The target FA 210 may respond to the HA 130 with an Agent Advertisement Message 230 which may include the FA's CoA. The HA 130 may transmit the FA's CoA 235 to the MIIS 538, which then may transmit a GetInformationResp message 240 to the MIH client 110 that may include the FA's CoA. The CoA is the target address that the WTRU may register to during handover.

The MIH client 110 may transmit a LinkGoingDown (high confidence) message 139 to the MIH server 537 if link quality is poor. The MIH server 537 may decide to initiate a handover. The MIH client 110 may trigger the MIP client 111 when a handover should be performed and when the targeted CoA is known. The targeted CoA may be obtained using an alternative method as described in FIG. 7. The current link (Network A) may be used to carry the MIP pre-registration destined for the FA on the targeted network. This may be performed by sending an MIP Register message 540 including (WTRU+CoA(B)+simultaneous binding) to the targeted FA 210. The FA 210 may then send an MIP Register message 545 including (WTRU+CoA(B)+simultaneous binding) to the HA 130. In response, the HA 130 may add the new CoA(B) binding entry for the WTRU while retaining the previous CoA(A) entry and may send an MIP Register Rsp message 550 to the target FA 210. The FA 210 then may send an MIP Register Rsp message 555 over the current link (Network A) to the MIH client 110. The targeted FA 210 may buffer the packets destined to the WTRU 105 until the WTRU 105 is detected on the targeted network.

The WTRU 105 may turn down 570 its current link on Network A and turn on a modem to connect to Network B. This is where connectivity may be interrupted. The WTRU 105 then may establish Layer 2 connectivity on Network B 575. Layer 3 connectivity may be resumed since the MIP registration was performed prior to initiating the handover. The FA 210 may forward the buffered packets 577 to the WTRU 105 and stop buffering. The MIH client 110 may trigger MIP registration using the previously-received CoA. It may send an MIP Register message 579 including (WTRU+CoA) to the FA 210 on Network B. The FA 210 on Network B may send an MIP register message 580 including (WTRU+CoA) to the HA 130. The HA 130 may remove the duplicate binding entries, retaining only the new CoA for the WTRU 105. The HA 130 may respond to the FA 210 by sending an MIP Register Rsp message 582. The FA 210 in Network B may send an MIP Register Rsp message 584 to the WTRU 105. The WTRU 105 may send a Handover Completed message 586 to the MIH server 537. The HA 130 may forward data 588 from the Network B using the new CoA.

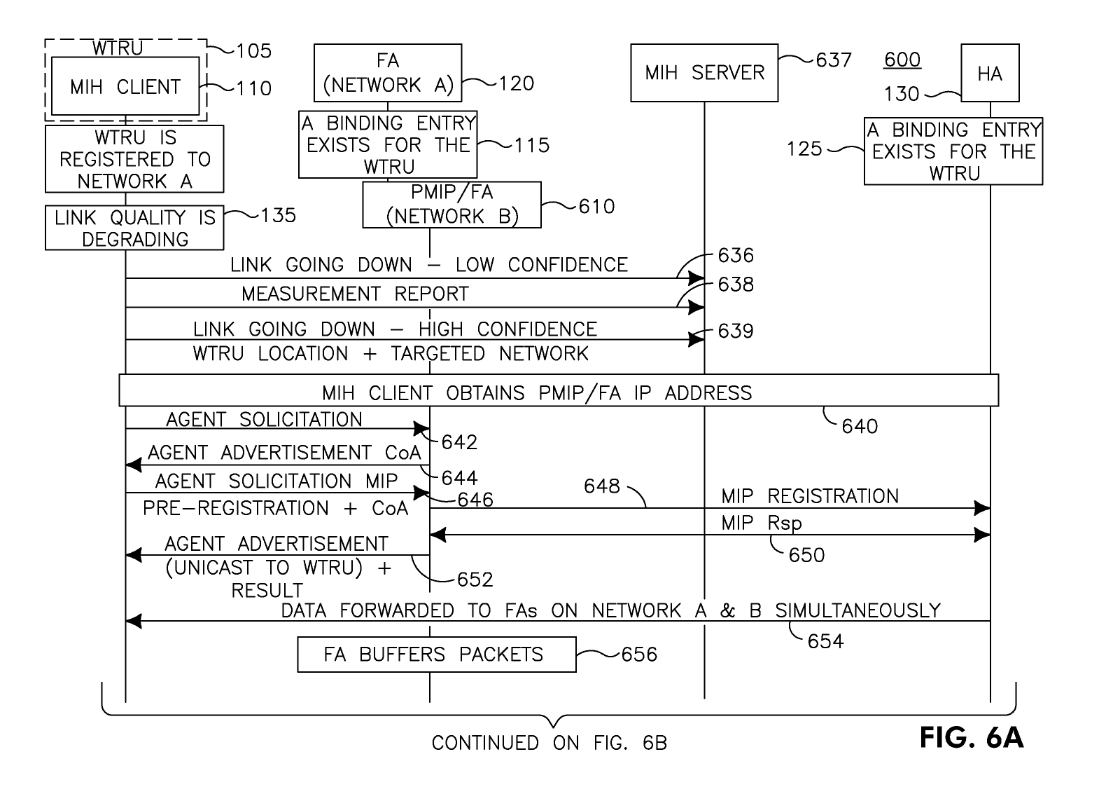

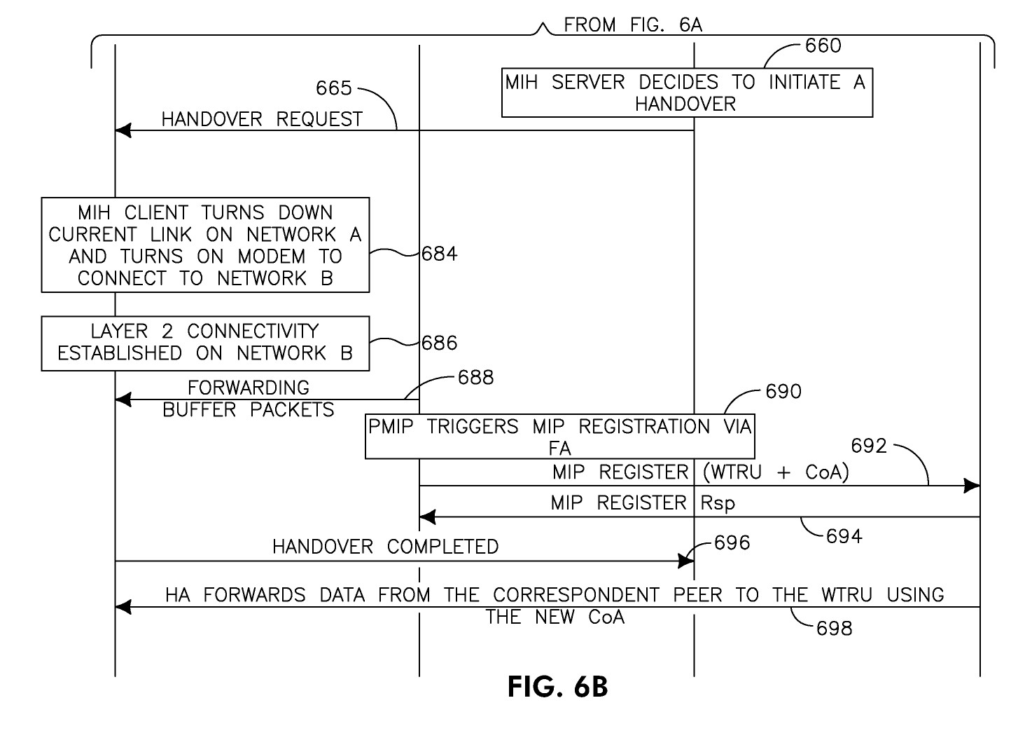

FIGS. 6A and 6B are a diagram of a method for MIH handover 600 where PMIP may be triggered by the MIH client. As PMIP is used in this method, an MIP client may not be required on the WTRU.

As shown in FIG. 6A, the WTRU 105 may include an MIH client 110 and may be registered on Network A. A binding entry 115, 125 may exist for the WTRU 105 at the FA 120 on Network A and at the HA 130. When the WTRU 105 detects that its link quality is degrading 135, it may send a LinkGoingDown (low confidence) message 636 to the MIH server 637. The WTRU 105 may send a measurement report 638 to the MIH server 637. The WTRU 105 may send a LinkGoingDown (high confidence) message 639 to the MIH server 637. The LinkGoingDown (high confidence) message 639 may include the WTRU location and the targeted network.

The MIH client 110 may obtain 640 the targeted PMIP/FA IP address using MIH Information Services, for example a Push Information from the MIH server 637 or a Get Information from the MIH client 110. The MIH client 110 may obtain the targeted CoA and trigger the MIP pre-registration with the targeted PMIP/FA 610 and the HA 130 by sending an Agent Solicitation message 642. In response, the PMIP/FA 610 may send an Agent Advertisement CoA 644. The MIH client 110 may then trigger the MIP pre-registration on the targeted Network B by sending a modified Agent Solicitation message 646 with a selected CoA to the PMIP/FA 610. The MIP pre-registration at the HA 130 may be performed by the targeted PMIP/FA 610 by sending an MIP Registration message 648 to the HA 130. This may be performed by keeping simultaneous bindings at the HA 130 and buffering packets on the targeted network until the WTRU 105 is attached to the targeted network. The HA 130 may then send an MIP Rsp message 650 to the PMIP/FA 610 in response. The PMIP/FA 610 may then send an Agent Advertisement message 652 to the MIH client 110. The Agent Solicitation message 646 and the Agent Advertisement message 652 may be modified to specify that MIP pre-registration is required to exchange these messages using unicast IP addresses. It is noted that the WTRU 105 sending these messages to the PMIP/FA 610 on the targeted Network B may still be connected to Network A. The HA 130 may forward 654 data to the FAs 120, 610 on Network A and Network B simultaneously while the PMIP/FA 610 buffers packets 656.

The MIH server 637 may then decide to initiate 660 a handover by sending a handover request message 665. The WTRU 105 may turn down 684 its current link on Network A, causing an interruption of connectivity, and establish Layer 2 connectivity 686 on Network B. Layer 3 connectivity may be resumed since the MIP registration was performed prior to initiating the handover. The PMIP/FA 610 may forward the buffered packets 688 to the WTRU 105 and stop buffering. The PMIP/FA 610 may trigger MIP registration 690 on Network B. The PMIP/FA 610 on Network B may determine that a binding entry already exists for the WTRU 105. The PMIP/FA 610 may send an MIP Register message 692 including (WTRU+registered CoA) to the HA 130, using the same CoA as used for the MIP registration update. The HA 130 may retain only the new CoA. The HA 130 may send an MIP Register Rsp message 694 to the PMIP/FA 610 in Network B. The WTRU 105 may send a Handover Completed message 696 to the MIH server 637. The HA 130 may forward data 698 from the correspondent peer to the WTRU using the new CoA.

As described in the methods above, the targeted CoA may be acquired via an exchange of Agent Solicitation and Agent Advertisement messages with the targeted FA. The Agent Solicitation may be sent by the HA, as shown in FIGS. 2 through 5. In one alternative, the MIH client may send the Agent Solicitation message instead of the HA, as shown in FIG. 6. Another alternative may be for the MIH server to send the Agent Solicitation message, as shown in FIG. 7.

As shown in FIG. 7, the MIH server 737 may initiate an acquisition of the targeted CoA by sending an Agent Solicitation message 750. The targeted CoA may then be forwarded to the MIH client 110 using a GetInformationRsp message 755. The acquisition of the targeted CoA alternatives shown in FIG. 7 may apply to other methods including those shown in FIGS. 2-6.

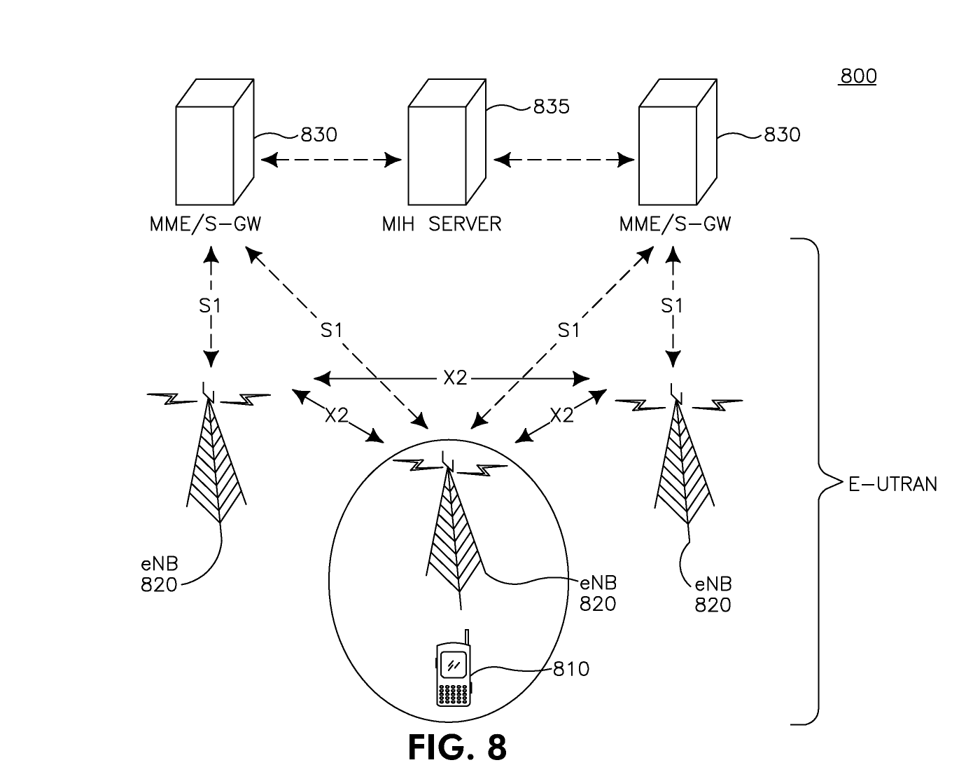

FIG. 8 is a diagram of an example wireless communication system/access network 800 that includes an Evolved-Universal Terrestrial Radio Access Network (E-UTRAN) 805. The E-UTRAN 805 may include a WTRU 810 and several evolved Node Bs, (eNBs) 820. The WTRU 810 may be in communication with an eNB 820. The eNBs 820 may interface with each other using an X2 interface. Each of the eNBs 820 may interface with a Mobility Management Entity (MME)/Serving GateWay (S-GW) 830 through an S1 interface. An MIH server 835 may be in communication with the MME/S-GW 830. Although a single WTRU 810 and three eNBs 820 are shown in FIG. 8, it should be apparent that any combination of wireless and wired devices may be included in the wireless communication system access network 800.

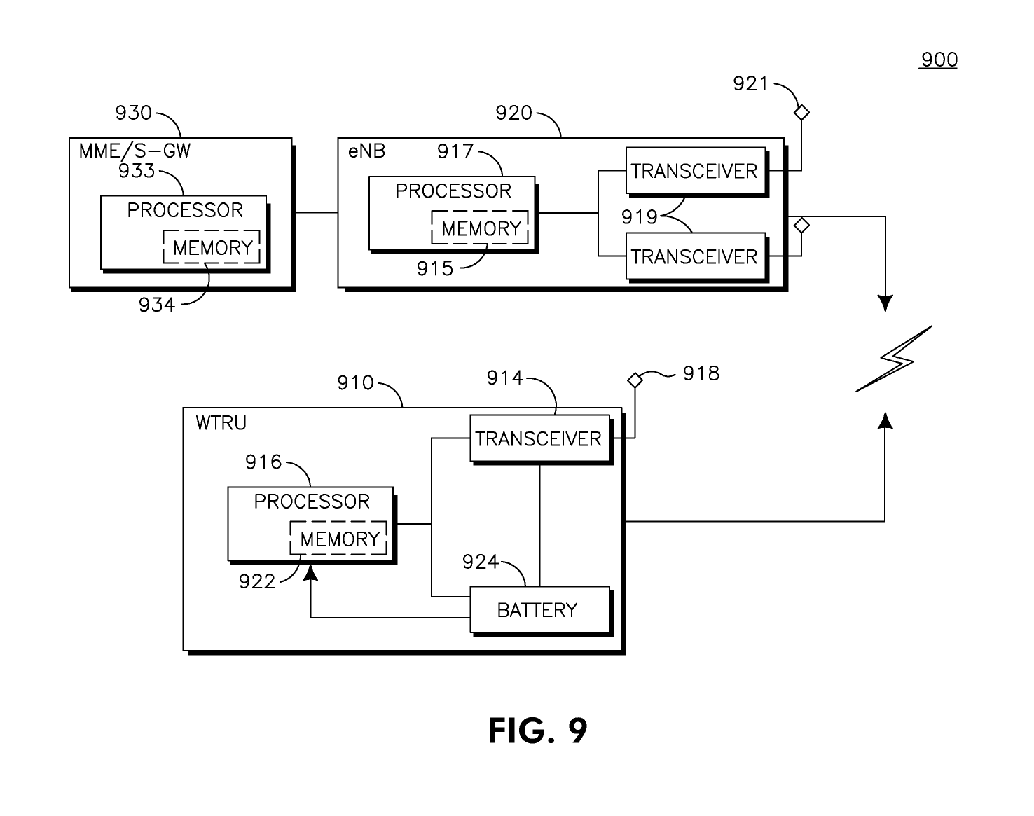

FIG. 9 is a block diagram of an example wireless communication system 900 including the WTRU 910, the eNB 920, and the MME/S-GW 930. As shown in FIG. 9, the WTRU 910, the eNB 920 and the MME/S-GW 930 may be configured to perform a BBM MIH in accordance with the examples provided above.

In addition to the components that may be found in a typical WTRU, the WTRU 910 may include a processor 916 with an optional linked memory 922, at least one transceiver 914, an optional battery 920, and an antenna 918. The processor 916 may be configured to perform a break-before-make media independent handover in accordance with the examples provided above. The transceiver 914 may be in communication with the processor 916 and the antenna 918 to facilitate the transmission and reception of wireless communications. A battery 920 may be used in the WTRU 910 to power the transceiver 914 and the processor 316.

In addition to the components that may be found in a typical eNB, the eNB 920 may include a processor 917 with an optional linked memory 915, transceivers 919, and antennas 921. The processor 917 may be configured to perform a break-before-make media independent handover in accordance with the examples provided above. The transceivers 919 may be in communication with the processor 917 and antennas 921 to facilitate the transmission and reception of wireless communications. The eNB 920 may be connected to the Mobility Management Entity/Serving GateWay (MME/S-GW) 930 which may include a processor 933 with an optional linked memory 934.

The GetInformation messages described above may be used to carry a WTRU's location, an indication of the targeted network, and an indication of the targeted FA's CoA. Additionally, a LinkGoingDown message may include an indication of a WTRU's location. Further, a Handover Request message may include a target FA's CoA.

In the examples described above, an MIH server may request the creation of a new simultaneous binding entry for a WTRU in the HA. The methods may include a new message from the HA to the FA to register the WTRU during MIP pre-registration. Additionally, a Router Solicitation message may include a Mobility Agent extension. A Router Solicitation message may include a Mobility Agent Advertisement Extension. The HA may send an Agent Solicitation to the FA with the H bit set to indicate that the HA which originated the message. When the FA receives an Agent Solicitation message with the H bit set, it may respond with an Agent Advertisement (containing the CoAs) unicast to the HA.

An HA may send an MIP registration on behalf of the WTRU to the targeted FA. In such a case, the lifetime may not be equal to zero. If the source IP address is the same as the HA IP address included in the message, the FA may send the response to the HA. In such a case, the FA may not be required to forward the registration request to the HA.

Data destined to a WTRU may be tunneled to the target IP address as soon as the Layer 2 connection is established on the target network, thus reducing interruption time. The methods and apparatus may utilize MIH to facilitate inter-technology MIP re-registration at a targeted FA. By allowing the MIH server to trigger MIP pre-registration on behalf of a WTRU, the network may control WTRU operation. The methods and apparatus may be applicable to contexts where handover is triggered based on criteria other than link quality. For example, the methods and apparatus may be applicable where an MIH server triggers a handover even where link quality is acceptable in order to achieve load balancing.

When simultaneous bindings are used at the HA during handover, data may be sent from the HA to both FAs. When simultaneous bindings are used, there may be no need for data to be buffered at the current FA and the target FA. There may also be no need to reserve memory for buffering or tunnel data between the current FA and the target FA.

The acquisition of the target CoA in the examples above may be transparent to the WTRU. In addition, the MIP re-registration with the targeted network may be transparent to the WTRU and no additional network nodes may be required.

Although the above methods are described with reference to 802.21 and an MIH server, they may also be applied using any technology that supports heterogeneous access technology handover. For example, an ANDSF server, among other types of devices in other mobility technologies may be implemented using the methods described above.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for inter-network handover for use in a wireless transmit/receive unit (WTRU), comprising:
receiving data from a source node in a source network serving the WTRU;
transmitting a first message to an intermediary node, the first message including an indication of a location of the WTRU and an indication of a target network;
receiving a second message from the intermediary node, the second message including an indication of an internet protocol (IP) address of a target node;
establishing connectivity on the target network; and
receiving data from the target node.

2. The method of claim 1, wherein the first message is a GetInformationRequest message and the second message is a GetInformationResponse message.

3. The method of claim 1 further comprising:
transmitting a third message to the target node, the third message including the IP address of the target node;
receiving a fourth message from the target node;
transmitting a fifth message to the intermediary node; and
receiving data from the target network.

4. The method of claim 3, wherein the third message is a mobile internet protocol (MIP) Registration message and the fourth message is an MIP Registration Response message.

5. The method of claim 3, wherein the fifth message is a Handover complete message.

6. A method for inter-network handover for use in a Mobile Internet Protocol (MIP) target node, comprising:
receiving a first message from a source node;
transmitting a second message to the source node;
receiving a third message from the source node indicating a wireless transmit/receive unit (WTRU) to be registered;
transmitting a fourth message to the source node; and
forwarding data to the WTRU.

7. The method of claim 6, wherein the first message is an Agent Solicitation message and the second message is an Agent Advertisement message.

8. The method of claim 6, wherein the third message is an MIP Registration message and the fourth message is an MIP Registration Response message.

9. The method of claim 6, further comprising:
transmitting a fifth message to the source node; and
receiving a sixth message from the source node.

10. The method of claim 9, wherein the sixth message includes an indication of a Care of Address (CoA) of the target node.

11. The method of claim 6, wherein the fourth message includes an indication of a Care of Address (CoA) of the target node.

12. The method of claim 6, wherein the Agent Advertisement message includes an indication of the Care of Address (CoA) of the target node.

13. A method for inter-network handover for use in an intermediary node, comprising:
transmitting a first message to a Mobile Internet Protocol (MIP) source node, the first message indicating a dual MIP binding for a wireless transmit/receive unit (WTRU); and
receiving a second message from the source node.

14. The method of claim 13, wherein the first message is a Registration message and the second message is a Registration Response message.

15. The method of claim 13, further comprising:
performing a determination to initiate handover of the WTRU; and
transmitting a Handover Request to the WTRU.

16. The method of claim 15, further comprising:
receiving a Handover Completed message from the WTRU.

17. A wireless transmit/receive unit (WTRU) comprising:
a receiver configured to receive data from a source node in a source network serving the WTRU;
a transmitter configured to transmit a first message to an intermediary node, the first message including an indication of a location of the WTRU and an indication of a target network; and
a media independent handover (MIH) client configured to establish connectivity on the target network;
wherein the receiver is further configured to receive a second message from the intermediary node, the second message including an indication of a Care of Address (CoA) of a target node and receive data from the target node.

18. The WTRU of claim 14, wherein the transmitter is further configured to transmit a third message to the target node, the third message including the CoA of the target node and the receiver is further configured to receive a fourth message from the target node.

19. The WTRU of claim 15, wherein the transmitter is further configured to transmit a fifth message to the intermediary node and the receiver is further configured to receive data from the target network.

20. The WTRU of claim 14, wherein the transmitter is further configured to transmit a measurement report.
